(19) United States
(12) Patent Application Publication
(10) Pub. No.: US 2004/0117382 A1
(43) Pub. Date: Jun. 17, 2004

(54) Method and apparatus for customizing the output of a user command

(75) Inventors: Autumn A. Houseknecht, Poughkeepsie, NY (US); Shaun Ijeomah, Poughkeepsie, NY (US)

Correspondence Address: William A. Kinnaman, Jr., IBM Corporation - IPLaw Department, 2455 South Road - M/S 386, Poughkeepsie, NY, 12601, US

(73) Assignee: International Business Machines Corporation, Armonk, NY

(21) Appl. No.: 10/320,964

(22) Filed: Dec. 17, 2002

(51) Int. Cl. G06F 7/00

(52) U.S. Cl. 707/100

(57) ABSTRACT

A method and apparatus for customizing the output of a user command in a UNIX operating system or other operating system having a command shell. A configuration file specifies an output format for each of one or more user command. In response to receiving a user command, the command shell processes the command to generate an output and formats the output in accordance with the configuration file. The configuration file may specify attributes such as color and font either for a command as a whole or for specified fields of the command. The configuration file may be a default configuration file or may be specified in the command line. The command line may also contain a flag indicating that no configuration file is to used and that default attributes are to be applied.

### BACKGROUND OF THE INVENTION

1. Field of the Invention

This invention relates to a method and apparatus for customizing the output of a user command. More particularly, it relates to a method and apparatus for customizing the output of UNIX shell commands prior to running such commands.

2. Description of the Related Art

As is well known in the art, operating systems are the software programs that perform services for user applications and manage the resources of a computer system. A well-known part of such operating systems is the command interpreter, or command shell as it is often called. UNIX-based operating systems have several well-known shells such as csh and tcsh, while Microsoft Windows operating systems have the MS-DOS prompt. Command shells provide a direct interface between the computer and the user (as distinguished from user programs running on the computer), allowing the user to perform such functions as managing files, starting and stopping programs, and the like. In UNIX-based operating systems, commands allow users to manipulate and display information pertaining to files, system setup, users and groups. In short, shell commands, as they are called, allow a user to navigate within the operating system environment. Shell commands for one UNIX-based operating system, the UNIX System Services component of the IBM z/OS operating system, are described in the IBM publication z/OS UNIX System Services Command Reference, SA22-7802-03 (June 2002), incorporated herein by reference.

As a particular example, a commonly used UNIX shell command is the ls command for displaying file and directory information, described at pages 328-334 of the referenced publication. When used with a variety of its options, the output from the ls command displays various attributes of a file. For example, ls-l will display file permissions, links attributed to a particular file, user ID (UID), group ID (GID), file size, date of the last time the file was altered, and file name. A sample output from the ls-l command would look like the following:

| | | | | |
|---|---|---|---|---|
| -rw------- | 1 USER GROUP | 46872 | Apr 24 18:30 | file |
| -rw------- | 1 USER GROUP | 27 | Jul 26 2000 | file |
| -rw-rw-rw- | 1 USER GROUP | 4486 | Mar 13 11:23 | file |
| -rw------- | 1 USER GROUP | 391 | Mar 2 16:01 | file |
| -rwx------ | 1 USER GROUP | 42 | Feb 2 17:20 | file |
| -rw------- | 1 USER GROUP | 30 | Oct 2 2000 | file |

While shell commands such as this provide various formatting options, they offer no easy method for the user to manipulate and customize command output. In order for a user to be able to manipulate the output of such shell commands, the user would have to be experienced in writing shell scripts. The experience necessary to write such complex shell scripts would preclude the novice user from having the ability to manipulate command output.

### SUMMARY OF THE INVENTION

In general, the present invention contemplates a method and apparatus for customizing the output of a user command in a UNIX operating system or other operating system having a command shell. Configuration data, preferably contained in a configuration file, specifies an output format for each of one or more user commands. In response to receiving a user command, the command shell processes the command to generate an output and formats the output in accordance with the configuration data.

The configuration data may specify attributes such as color and font either for a command as a whole or for specified fields of the command. The configuration data may be default configuration data or may be specified in the command line. The command line may also contain a flag indicating that no configuration data is to used and that default attributes are to be applied.

The present invention gives users the ability to assign properties to the output of shell commands, prior to running those commands. While the present invention is not limited to UNIX shell commands, as applied to such shell commands this invention would build upon the current POSIX standard and would constitute an extension of such standard.

### BRIEF DESCRIPTION OF THE DRAWINGS

FIG. 1 shows a computer system incorporating the present invention.

FIG. 2 shows the functional elements of the command interpreter shows in FIG. 1.

FIG. 3 shows the steps performed by the user.

FIG. 4 shows the steps performed by the command interpreter.

### DESCRIPTION OF THE PREFERRED EMBODIMENT

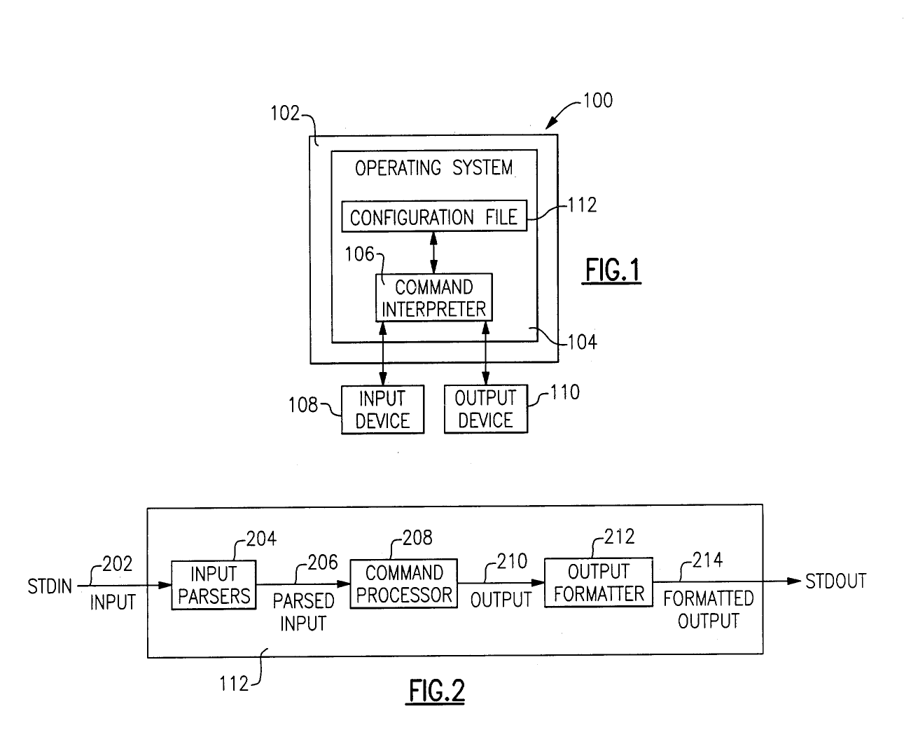

FIG. 1 shows a computer system 100 incorporating the present invention. Computer system 100 comprises a hardware machine 102 having an operating system 104 and typically one or more user applications (not shown) running thereon. Hardware machine 102 may be any suitable type known to the art, such as an Intel-architecture (e.g., Pentium) machine, a RISC machine, or a “mainframe” machine such as an IBM eServer zSeries server. Further, while referred to herein as a “machine”, hardware machine 102 may be a logical partition or a virtual machine of an underlying host machine (not shown). Operating system 104 may be any suitable type having a command shell, such as a UNIX-based operating system with a UNIX command shell or a Microsoft Windows operating system with a MS-DOS prompt. If hardware machine 102 is an IBM eServer zSeries server, then operating system 104 may be the UNIX System Services component of the IBM z/OS operating system.

Operating system 104 contains a command interpreter (or shell) 106. Command interpreter 106 responds to user commands entered by way of an input device 108 such as a keyboard or pointing device to generate an output on an output device 110 such as a display monitor or printer. In accordance with the present invention, and as described further below, command interpreter 106 formats its output in accordance with user-provided configuration data, preferably stored as a file 112.

FIG. 2 shows the functional elements of the command interpreter 106. As is conventional in UNIX systems, input from the input device 108 (consisting here of a command line entered by the user) is written to a standard input file (stdin) that may be read by programming. The contents of stdin are read in as an unparsed input 202 to an input parser 204 of the command interpreter 106. Input parser 204 parses the unparsed input 202 to produce a parsed input 206 that is supplied to a command processor 208 of the command interpreter 106. Command processor 208 in turn processes the parsed input to produce an unformatted output 210 that is supplied to an output formatter 212 of the command interpreter 106. Finally, output formatter 212 formats the output 210 to produce a formatted output 214. The formatted output 214 is written to a standard output file (stdout), from which it is written to the output device 110, as is conventional in UNIX systems.

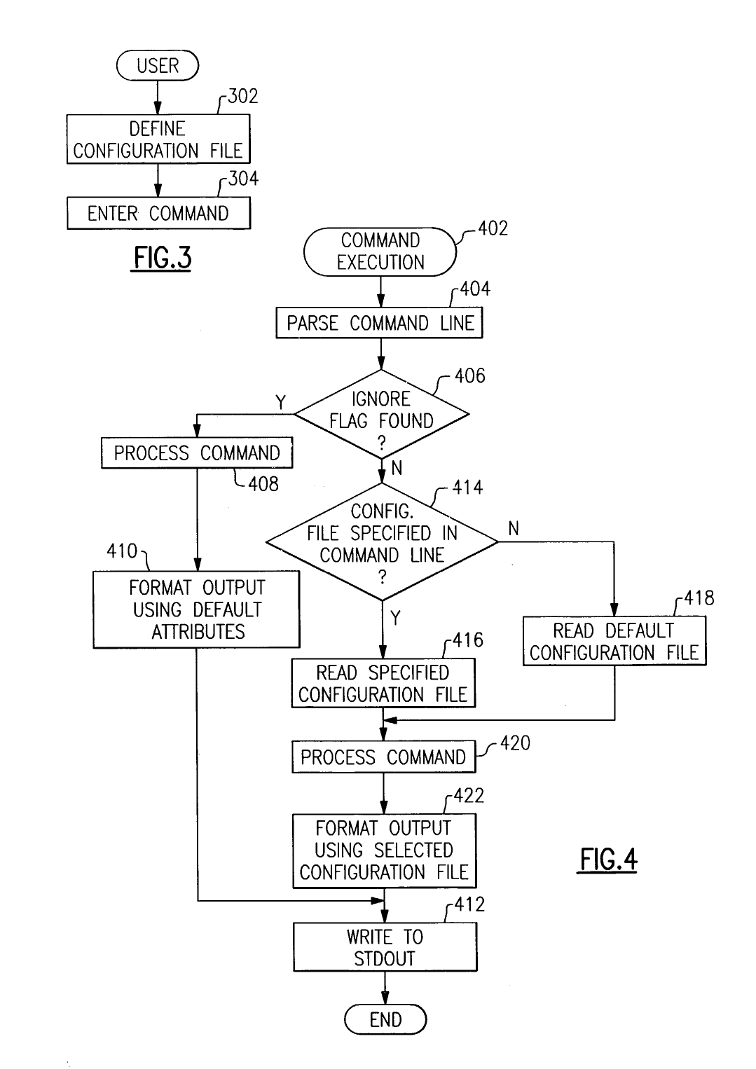

FIGS. 3 and 4 show the overall processing flow. FIG. 3 shows the steps performed by the user, while FIG. 4 shows the steps performed by the command interpreter 106.

Referring first to FIG. 3, at some point in time prior to running a command from which he desires formatted output, the user defines a configuration file 112 (step 302). This configuration file 112 could be implemented as a flat file and could be created manually or by a tool. Such a tool would have formatting capabilities similar to a word processor that would include functions such as changing the font or font size, allowing for boldface type, and adding color to the text. A user would then use this tool to apply formatting to text as he would in a word processor. The tool could be used to apply different formats to different commands by allowing the user to select a command output to format. After selecting a command to format, the tool would present sample output typical of the selected command. If the user wished to format a command that was not available in the selection, the user could create a “profile” for his command that included the command name, field names, field attributes, and sample output to format. When the user indicated that he was ready to write the configuration file 112, the tool would capture the formats applied by the user to sample output and write those attributes to a configuration file 112.

The configuration file 112 could be written in a format similar to the Visual Basic programming language, where a series of three qualifiers would indicate the formatting that applied to a particular field. The highest-level qualifier would differentiate the command. The second (or middle) qualifier would differentiate the field in the output of the command. The final and third qualifier would differentiate the attribute being set. The third qualifier would have a standard set of qualifiers that represented attributes that could be assigned to format the field, such as font, color, offset, and size. The high-level qualifier could be used without a middle-level qualifier to apply an attribute to all of the output associated with the command. The high-level qualifier and/or middle-level qualifier could also be used as an efficient method to turn off the formatting for a command by setting the value of the attribute to “OFF”. This capability would provide an easy method for ignoring some configuration settings without requiring the user to create a new configuration file 112 or modify his existing configuration file (other than to supply the OFF setting). Any configurations not defined would result in the default formatting being applied, as is conventionally done for command output.

A typical configuration file 112 might look like the following:

ls-l.color=green

ls-l.field2.offset=50

ls-l.field3.offset=10

ls-l.field3.color=pink

ls-l.field4.size=20

is-l.field4.offset=60

ls-l.field4=OFF

ps.font=courier

ps.size=10

In this file, line 1 contains only a first (command) qualifier, for the command ls-l and indicates that the color for all output for that command is green unless more specifically indicated. Lines 2-6 each contain a second (field) and third (attribute) qualifier as well, and indicate a specified value for the specified attribute in the specified field. Line 7, on the other hand, contains no third (attribute) qualifier but only a value (OFF), indicating that the default attributes rather than the attributes defined in lines 1, 5 and 6 of the configuration file 112 are to be used for field 4. Finally, lines 8 and 9 specify a pair of attributes (font and size) for the output of yet another UNIX shell command, the ps command for displaying status information about processes.

The user then issues a command from the shell such as ls-alg (step 304). In accordance with the present invention, the command line may specify a configuration file 112 as one of the input parameters; for example, the command line may read:

ls-l−cnfgfile<configfilename>

where−cnfgfile is the flag for specifying a configuration file 112 and <configfilename> is the name of the particular configuration file 112 being specified. If no configuration file 112 is specified in the command line, then a default configuration file 112 is used. A default configuration file 112 may be specified by an environment variable statement, such as:

CNFGFILE=<CONFIGFILENAME>

where CNFGFILE is the name of the environment variable and <CONFIGFILENAME> is the name of the default configuration file being specified.

The command line may also contain a flag that indicates to the command interpreter 106 that no configuration file 112, as specified either in the command line or by default, should be used. For example, the command line may read:

ls-l−nofrmt

where—nofrmt is a flag indicating that no configuration file 112 should be used. In such case, the command is processed normally and the output is formatted using the native “default” attributes of the command; i.e., the output is formatted as it would have been done “normally” in the absence of the present invention. This flag could also be used as a debugging feature that would allow the user to view the command output without formatting in the event the user's formatting had caused a field to not be displayed.

Referring now to FIG. 4, upon entry of a user command from input device 108 (step 402), the command interpreter 106 begins execution of the command. The parser 204 of the command interpreter 106 first parses the command line in a conventional manner to identify the command keyword itself together with any input parameters, options, flags, and the like (step 404). In accordance with the present invention, during this parsing step the parser 204 also checks for the flag to ignore the configuration settings contained in a configuration file 112 as well as for an explicit designation of a configuration file 112. If the flag is found (step 406), the command interpreter 106 proceeds to normal command processing in which the command processor 208 produces an output 210 (step 408) and the output formatter 212 formats that output to generate a formatted output 214 using the “default” attributes defined for the command (step 410); i.e., the command interpreter 106 formats the output as “normal”. Finally, the command interpreter 106 writes the formatted output 214 to the standard output device (stdout) (step 412).

If at step 406 the flag to ignore the configuration settings is not found, and if the command line explicitly designates a configuration file 112 (step 414), the command interpreter 106 reads the explicitly designated configuration file 112 and stores the configuration data for later use to format the output of the command when it is directed to standard output (stdout) (step 416). If no such configuration file 112 is explicitly designated, the command interpreter 106 stores the configuration data from the default configuration file 112 for use during formatting (step 418). In either event, the command interpreter 106 then proceeds to normal command processing by the command processor 208 as it did in step 408 (step 420). Command processing proceeds as it does normally until output is ready to be written to stdout. Then, instead of using the default formatting attributes as in step 410, the output formatter 212 of the command interpreter 106 uses the stored configuration data to apply the attributes assigned to the output from the selected configuration file 112—either the explicitly designated configuration file 112 or the default configuration file 112 as the case may be (step 422). Output is formatted per the specifications of the selected configuration file 112. If an attribute is not assigned to a field or command, default attributes are applied (such as were available before the command formatting of the present invention). Finally, the command interpreter 106 writes the formatted output to stdout (step 412).

While a particular embodiment has been shown and described, various modifications will be apparent to one skilled in the art. Thus, while the invention has been described in the context of a UNIX command shell, the invention may also be used in other systems, such as the MS-DOS prompt of a Microsoft Windows operating system.

What is claimed is:

1. In an information handling system in which a user enters a command line of a command into the system to obtain an output for the command therefrom, a method of customizing said output, comprising the steps of:
storing configuration data specifying a format for said output of said command; and
in response to entry by a user of a command line for said command into said system, processing said command line to generate an output for said command, and formatting said output in accordance with the format specified for said output by said configuration data.

2. The method of claim 1 in which said configuration data is stored as a file.

3. The method of claim 1 in which said configuration data specifies a format for the output of each of a plurality of commands.

4. The method of claim 1 in which said configuration data specifies a format for each of a plurality of fields of the output of said command.

5. The method of claim 1 in which said configuration data specifies each of a plurality of attributes of the output of said command.

6. The method of claim 1 in which said processing step includes the steps of parsing said command line to decode said command and processing said command to generate said output.

7. The method of claim 1 in which said processing step includes the step of parsing said command line for a specification of particular configuration data, said output being formatted in accordance with said particular configuration data if it is specified by said command line.

8. The method of claim 1 in which said processing step includes the step of parsing said command line for a flag to ignore said configuration data, said output being formatted independently of said configuration data if said flag is contained in said command line.

9. In an information handling system in which a user enters a command line of a command into the system to obtain an output for the command therefrom, apparatus for customizing said output, comprising:
a configuration data store for storing configuration data specifying a format for said output of said command; and
a command line processor responsive to entry by a user of a command line for said command into said system for processing said command line to generate an output for said command and formatting said output in accordance with the format specified for said output by said configuration data.

10. The apparatus of claim 9 in which said configuration data is stored as a file.

11. The apparatus of claim 9 in which said configuration data specifies a format for the output of each of a plurality of commands.

12. The apparatus of claim 9 in which said command line processor comprises a command line parser for parsing said command line to decode said command, a command processor for processing said command to generate an output, and an output formatter for formatting said output to generate a formatted output.

13. The apparatus of claim 12 in which said command line parser parses said command line for a specification of particular configuration data, said output formatter formatting said output in accordance with said particular configuration data if it is specified by said command line.

14. The apparatus of claim 12 in which said command line parser parses said command line for a flag to ignore said configuration data, said output formatter formatting said output independently of said configuration data if said flag is contained in said command line.

15. A program storage device readable by a machine, tangibly embodying a program of instructions executable by the machine to perform method steps for customizing an output for a command in an information handling system in which a user enters a command line of the command into the system to obtain said output therefrom, said method steps comprising:
storing configuration data specifying a format for said output of said command; and
in response to entry by a user of a command line for said command into said system, processing said command line to generate an output for said command, and formatting said output in accordance with the format specified for said output by said configuration data.

16. The program storage device of claim 15 in which said configuration data is stored as a file.

17. The program storage device of claim 15 in which said configuration data specifies a format for the output of each of a plurality of commands.

18. The program storage device of claim 15 in which said processing step includes the steps of parsing said command line to decode said command and processing said command to generate said output.

19. The program storage device of claim 15 in which said processing step includes the step of parsing said command line for a specification of particular configuration data, said output being formatted in accordance with said particular configuration data if it is specified by said command line.

20. The program storage device of claim 15 in which said processing step includes the step of parsing said command line for a flag to ignore said configuration data, said output being formatted independently of said configuration data if said flag is contained in said command line.
